(19) United States
(12) Patent Application Publication
(10) Pub. No.: US 2007/0128362 A1
(43) Pub. Date: Jun. 7, 2007

(54) Use of protective colloids-stabilized polymers for double dot coatings

(75) Inventors: Gertrud Schönmann, Grafelfing (DE); Peter Weiler, Geretsried (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DR. TH. BOHME KG CHEM. FABRIK GMBH & CO., Geretsried (DE)

(21) Appl. No.: 10/582,072

(22) PCT Filed: Dec. 1, 2004
(86) PCT No.: PCT/EP04/13642

§ 371 Date: Jun. 8, 2006

(30) Foreign Application Priority Data
Dec. 12, 2003 (EP) 03 028 481.4

(51) Int. Cl. B05D 5/00

(52) U.S. Cl. 427/258

(57) ABSTRACT

The use of a protective colloid-stabilized polymer is described, comprising a protective colloid and a polymer, for coating of a substrate, said coating being a double dot coating.

The invention relates to the use of a protective colloid-stabilized polymer for coating of a substrate.

For the adhesion of textile materials, such a material may be coated, for example, with a thermosetting adhesive powder and then adhesion-bonded with a second material placed thereon. One possibility of coating is the so-called double dot coating. This initially involves printing a lower dot onto the material to be coated. Said printing may be effected by rotary screen printing. The lower dot may be a paste comprising an aqueous dispersion of an emulsifier-stabilized polymer, thickeners and, optionally, printing auxiliaries. Thermosetting adhesive powder is then dusted onto the still wet lower dot. Any excess powder is removed by suction. Subsequently, the lower dot with the thermosetting adhesive powder is first dried and sintered, or the thermosetting adhesive powder is melted.

An example of double dot coating is described in EP 0 547 261 B1 which discloses a coated plane structure which comprises a coating substrate (presently also referred to as substrate), a base or basic layer of a plastic mass (presently also referred to as lower dot) and a second layer (presently also referred to as thermosetting adhesive) provided thereon. The base layer is prepared from a cross-linkable, aqueous polymer dispersion, polymer emulsion and/or polymer solution. As polymer dispersions, self-crosslinking acrylic polymers, self-crosslinking polyvinyl esters or self-crosslinking styrene-acryl ester copolymers or acryl-vinyl ester copolymers were used. The polymers used preferably have a film formation temperature of at least 5° C. and are, in most cases, set to be acidic when in the form of dispersions or emulsions.

The adhesion values of the adhesions after washing and dry cleaning are disadvantages of this double dot coating. The rheological behavior and the drying of the paste on the template during rotary screen printing result in a poor processing behavior.

Thus, it is the object of the present invention to eliminate these disadvantages.

According to the invention, this is achieved by the use of a protective colloid-stabilized polymer, comprising a protective colloid and a polymer, for coating of a substrate, said coating being a double dot coating.

It was a complete surprise for the person skilled in the art that a protective colloid-stabilized polymer is suitable at all for coating a substrate, e.g. a textile material, for subsequent adhesion. A prerequisite to the adhesion (bonding) of textile materials is that the adhesion is not dissolved during washing or cleaning. However, the person skilled in the art expects protective colloid-stabilized polymers to be soluble and consequently expects that the adhesion produced thereby with textiles will be dissolved by washing. Surprisingly, however, this was not observed. Rather, it was even found that the adhesion obtained by the use of protective colloid-stabilized polymers show great resistance to washing and cleaning.

The polymers used so far in the prior art for coatings, in particular double dot coatings, include among others emulsifier-stabilized polymers. Emulsifiers are compounds which can be summarized under the term “tensides”. Protective colloids are also surface active substances, but they differ quite characteristically from tensides. A characteristic property of tensides and their solutions is the micelle formation. As the tenside concentration increases, the number of molecules at the interface increases until there is no space for any further molecules. This is the time for micelle formation. Detached aggregates of a greater number of tenside molecules or ions are referred to as micelles. They are dynamic structures which are at equilibrium with the solution surrounding them. Micelle formation sets in within a very narrowly limited concentration range that is characteristic for each tenside and depends on the molecule structure. It occurs at that concentration at which the surface is completely or almost completely taken up and at which, therefore, the surface tension becomes independent of the increase in concentration. Measuring the surface tension as a function of the concentration allows an easy determination of the concentration at which micelles begin to form. It is referred to as critical micelle formation concentration (CMC). Further, the term “HLB value” (hydrophilic-lipophilic balance) was introduced to characterize tensides. It characterizes tensides according to hydrophilic and hydrophobic groups, taking the structure into consideration. Determination of the HLB value relies on an empirical basis:
HLB=20(1−M0/M),
wherein M0 designates the weight of the hydrophobic part of the molecule and M refers to the total molecular weight.

Both the critical micelle formation concentration and the HLB value are characteristic properties of tensides and their solutions. Protective colloids have neither of these properties.

Protective colloid-stabilized polymers are known to the person skilled in the art. They are commercially available or may be prepared by radical-initiated polymerization of the monomers mentioned below and, where appropriate, of auxiliary monomers. The radical-initiated polymerization of ethylenically unsaturated monomers may be effected by suspension polymerization or emulsion polymerization. In suspension polymerization and emulsion polymerization, the polymerization is effected in the presence of surface active compounds composed of 100-51% of protective colloids and 0-49% of emulsifiers. Suitable emulsifiers are anionic, cationic and non-ionic emulsifiers, e.g. anionic tensides, such as alkyl sulfates having a chain length of 8 to 18 carbon atoms, alkyl or alkylaryl ether sulfates comprising 8 to 18 carbon atoms in the hydrophobic residue and up to 60 ethylene or propylene oxide units, alkyl or alkylaryl sulfonates comprising 8 to 18 carbon atoms, esters and half-esters of sulfosuccinic acid with monovalent alcohols or alkyl phenols, or non-ionic tensides, such as alkyl polyglycol ether or alkylaryl polyglycol ether comprising up to 60 ethylene oxide or propylene oxide moieties.

Particularly preferred examples of protective colloids include modified natural polymers, such as O-methylcellulose, O-(2-hydroxyethyl)cellulose, O-(2-hydroxypropyl)cellulose, O-(2-hydroxy-propyl)-O-methylcellulose, O-(2-hydroxybutyl)-O-methyl-cellulose, carboxymethylcellulose (Na salt), starch ether, O-(2-hydroxypropyl) starch and lignosulfonic acid, synthetic homo- and copolymers, such as poly(vinyl alcohol) [partially saponified poly(vinyl acetate)], poly(vinyl alcohol co-ethylene), poly(methacrylic acid sodium salts), poly[methacrylic acid sodium salt co-(methacrylic acid methylester)], poly[acrylic acid co-acrylic acid (2-ethylhexyl ester)], poly[methacrylic acid (hydroxyalkyl ester)], poly(styrene co-maleic acid sodium salt), poly(styrene-4-sulfonic acid sodium salt co-maleic acid half-ester), poly(ethylene co-maleic acid partial ester), poly(oxirane), poly(alkyl)vinyl ether, poly(acrylic acid sodium salt), poly(alkylvinyl ether co-maleic acid anhydride), poly(vinyl acetate co-maleic acid anhydride), poly(1-vinyl-2-pyrrolidone), poly[(1-vinyl-2-pyrrolidone) co-methacrylic acid alkyl ester], poly[(1-vinyl-2-pyrrolidone) co-methacrylamide], poly(vinyl pyridine) and poly(diallyl dimethyl ammoniumchloride), graft polymers, such as poly(vinyl chloride-g-vinyl alcohol), poly(styrene-g-vinyl alcohol), poly-(styrene-g-acrylic acid), poly[styrene-g-(1-vinyl-2-pyrrolidone)] and poly[acrylic acid t-butyl ester-g-(1-vinyl-2-pyrrolidone)], as well as condensation products, such as urea formaldehyde condensates, phenol formaldehyde condensates and alkyd resins.

The polymers of the protective colloid-stabilized polymers will be explained in more detail with reference to the monomers. Polymers in the sense of the present invention mean both homo-polymers and copolymers. The monomers may be ethylenically unsaturated monomers. These may be selected from vinyl esters of unbranched or branched alkyl carboxylic acids comprising 1 to 18 carbon atoms, acrylic acid esters or methacrylic acid esters of branched or unbranched alcohols comprising 1 to 18 carbon atoms, C₂-C₂₀ mono- or dicarboxylic acids, their amides, N-methylol amides or nitriles, C₂-C₂₀ sulfonic acids, 3-20-membered heterocyclic compounds comprising oxygen, sulfur, selenium, tellurium, nitrogen, phosphorus, boron or aluminum as heteroatom, dienes comprising at least 4 carbon atoms, olefines comprising at least 2 carbon atoms, aromatic vinyl compounds, in particular including benzene or naphthalene as the aromatic compound, and C₂-C₂₀ vinyl halides.

Preferred vinyl esters are those comprising 1 to 12 carbon atoms, in particular vinyl acetate, vinyl propionate, vinyl butyrate, vinyl-2-ethyl hexanoate, vinyl laurate, 1-methylvinyl acetate, vinyl pivalate and vinyl esters of α-branched monocarboxylic acids comprising 9 to 13 carbon atoms.

In a further preferred embodiment, the acrylic acid ester or the methacrylic acid ester is an ester of unbranched or branched alcohols comprising 1 to 15 carbon atoms, in particular methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate and 2-ethylhexyl acrylate, especially preferred methyl acrylate, methyl methacrylate, n-butyl acrylate, t-butyl acrylate, and 2-ethylhexyl acrylate.

Preferred mono- and dicarboxylic acids, their amides, N-methylol amides and nitriles are selected from acrylic acid, methacrylic acid, fumaric acid, maleic acid, acrylamide, N-methylol acrylamide, N-methylol methacrylamide and acrylonitrile.

The sulfonic acid is favorably selected from vinyl sulfonic acid and 2-acrylamido-2-methyl-propane sulfonic acid. The preferred heterocyclic compounds are vinyl pyrrolidone and vinyl pyridine.

The aromatic vinyl compound is preferably styrene, methyl styrene or vinyl toluene.

The vinyl halide is preferably vinyl chloride.

In a preferred embodiment of the use according to the invention, the olefin is selected from ethylene and propylene.

Preferred dienes are selected from 1,3-butadiene and isoprene.

The use according to the invention allows a plurality of different protective colloid-stabilized polymers to be employed.

Optionally, 0.1 to 50% by weight, based on the total weight of the monomer mixture, of auxiliary monomers may be copolymerized. Preferably, 0.5 to 15% by weight of auxiliary monomers are used. Examples of auxiliary monomers are ethylenically unsaturated C₂-C₂₀-mono- and dicarboxylic acids, preferably acrylic acid, methacrylic acid, fumaric acid and maleic acid; ethylenically unsaturated C₂-C₂₀-carboxylic acid amides and nitriles, preferably acrylamide and acrylonitrile; mono- and diesters of fumaric acid and maleic acid, such as their diethyl and diisopropyl esters; as well as maleic acid anhydride, ethylenically unsaturated C₂-C₂₀-sulfonic acids and their salts (alkali salts, alkaline earth salts and ammonium salts), preferably vinyl sulfonic acid, 2-acrylamido-2-methylpropane sulfonic acid. Further examples are pre-crosslinking C₂-C₂₀-comonomers, such as multiply ethylenically unsaturated comonomers, for example divinyl adipate, diallyl maleate, diallyl phthalate, allyl methacrylate or triallyl cyanurate, or post-crosslinking comonomers, for example acrylamidoglycolic acid (AGA), methylacrylamidoglycolic acid methylester (MAGME), N-methylol acrylamide (NMA), N-methylol methacrylamide, N-methylolallyl carbamate, C₂-C₂₀-alkyl ether, such as the isobutoxy ether or ester of N-methylol acrylamide, of N-methylol methacrylamide and of N-methylolallyl carbamate. Further examples are silicon functionalized C₂-C₂₀-comonomers, such as acryloxypropyl-tri(alkoxy)- and methacryloxy propyl-tri(alkoxy)silanes, vinyl trialkoxysilanes and vinyl methyl dialkoxysilanes, while ethoxy and ethoxypropylene glycol ether residues may also be contained as alkoxy groups. Mention should also be made of C₂-C₂₀-monomers comprising hydroxy- or CO-groups, for example methacrylic acid and acrylic acid hydroxyalkyl esters, such as hydroxyethyl, hydroxypropyl or hydroxybutyl acrylate or methacrylate, as well as compounds such as diacetone acrylamide and acetylacetoxy ethyl acrylate or methacrylate.

By copolymerisation of the above-described monomers with the auxiliary monomers, the properties of the coatings, such as adhesion, crosslinking and stabilization, can be favorably influenced.

Particularly preferably, the polymers are prepared from monomers or mixtures containing one or more monomers from the group of vinyl acetate, vinyl esters of α-branched monocarboxylic acids comprising 9 to 13 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate or styrene. Most preferred are mixtures of vinyl acetate and ethylene; of vinyl acetate, ethylene and a vinyl ester of α-branched monocarboxylic acids comprising 9 to 13 carbon atoms; of n-butyl acrylate, 2-ethylhexyl acrylate and/or methyl methacrylate; of styrene with one or more monomers from the group of methyl acrylate, ethyl acrylate, propyl acrylate, n-butyl acrylate, 2-ethylhexyl acrylate; of vinyl acetate with one or more monomers from the group of methylacrylate, ethylacrylate, propylacrylate, n-butylacrylate, 2-ethylhexyl acrylate and optionally ethylene; the aforementioned mixtures may also contain one or more of the above-mentioned auxiliary monomers, if required. These mixtures have turned out to be particularly favorable, because they show excellent properties in coatings at low cost.

The selection of monomers or the selection of parts by weight of the co-monomers may be effected so as to generally result in a glass transition temperature Tg of from −50° C. to +120° C., preferably from −30° C. to +95° C. The glass transition temperature Tg of the polymers can be determined in a known manner by means of Differential Scanning Calorimetry (DSC). The Tg may also be calculated in advance by means of the Fox equation. According to Fox T. G., Bull. Am. Physics Soc. 1, 3, p. 123 (1956) it is: 1/Tg=x1/Tg1+x2/Tg2+ . . . +xn/Tgn, wherein xn represents the mass fraction (% by weight/100) of the monomer n, and Tgn is the glass transition temperature in Kelvin of the homopolymer of the monomer n. Tg values for homopolymers are set forth in Polymer Handbook 2nd edition, J. Wiley & Sons, New York (1975).

The polymerization of the above-mentioned monomers and, where appropriate, auxiliary monomers to the resulting polymer can be radically initiated. The radically initiated polymerization of the ethylenically unsaturated monomers may be effected by suspension polymerization and emulsion polymerization.

The polymerization temperature may be from 40° C. to 100° C., preferably from 60° C. to 90° C. In the case of copolymerization of gaseous comonomers, such as ethylene, 1,3-butadiene or vinyl chloride, it is also possible to work under pressure, generally between 5 bar and 100 bar. Initiation of the polymerization can be effected with the usual water-soluble or monomer-soluble initiators or redox initiator combinations. Examples of water-soluble initiators are the sodium, potassium and ammonium salts of peroxodisulfuric acid, hydrogen peroxide, t-butyl peroxide, potassium peroxodiphosphate, t-butyl peroxopivalate, cumol hydroperoxide, isopropyl benzene monohydroperoxide, azo-bis isobutyronitrile. Examples of monomer-soluble initiators are dicetylperoxy dicarbonate, dicyclohexylperoxy dicarbonate, dibenzoyl peroxide, tert.-butyl-peroxy neodecanoate, tert.-butyl-peroxy-2-ethyl hexanoate and tert.-butylperoxy pivalate. The aforementioned initiators are generally used in an amount of from 0.01 to 10.0% by weight, preferably 0.1 to 0.5% by weight, respectively based on the total weight of the monomers. As redox initiators, combinations of the aforementioned initiators with reducing agents can be used. Suitable reducing agents are the sulfites and bisulfites of alkali metals and of ammonium, e.g. sodium sulfite, the derivatives of sulfoxylic acid, such as zinc or alkali formaldehyde sulfoxylates, e.g. sodium hydroxymethane sulfinate, and ascorbic acid. The amount of reducing agent is generally from 0.01 to 10.0% by weight, preferably from 0.1 to 0.5% by weight, respectively based on the total weight of the monomers.

The monomers may be provided first as a whole, may be added as a whole, or parts thereof may be provided first and the rest may be added after the initiation of the polymerization. The dosages may be effected separately (in space and in time), or all or some of the components to be dosed may be added in a pre-emulsified form.

In the methods mentioned as being preferred, i.e. suspension polymerization and emulstion polymerization, polymerization may be effected in the presence of the aforementioned protective colloids in order to prepare the protective colloid-stabilized polymers.

The present invention, in particular in the above-described preferred embodiments, has a multiplicity of advantages: First of all, it has been found that, in comparison with other coating methods according to the prior art, very small coating amounts are sufficient for a sufficiently good adhesion. This allows to achieve a clear reduction in costs, and the adhesion-bonded textile materials have a pleasantly soft touch. The adhesion-bonded textiles are found to have very good adhesion with the protective colloid-stabilized polymers used according to the invention. The adhesion of the dustable powder to the lower dot is very good. The adhesion obtained with the coating using a protective colloid-stabilized polymer have very high resistance to washing and cleaning. Moreover, the lower dot obtained with the protective colloid-stabilized polymer does not penetrate into the textile substrate during double dot coating, i.e. a very efficient backstroke trap is achieved. Further, pastes containing the protective colloid-stabilized polymer and used to produce the lower dot in double dot coatings have very good rheology and do not dry on the template.

In order to produce coatings on substrates, the protective colloid-stabilized polymers may be used in the form of a paste. Production of such a paste starts from a dispersion of the protective colloid-stabilized polymer in water. The amount of water may be, for example, about 70% by weight, based on the dispersion, and the amount of the protective colloid-stabilized polymer may be about 30% by weight, also based on the dispersion. To these polymer dispersions, thickener and, where appropriate, printing auxiliaries may be added, whereby pastes for coating are then obtained.

These pastes can be applied, for example, by rotary screen printing onto the substrate to be coated. This way, a lower dot can be produced for double dot coating. A meltable adhesive powder can then be added to the lower dot. Any excess powder can be subsequently removed by suction. The lower dot can then be dried and sintered, or the dustable powder can be melted.

The above-mentioned polymer dispersions have the advantage that they can be crosslinked by addition of compounds comprising 2 or more epoxide, organo, halogen, hydroxy, aziridine, carbodiimide, oxazoline, alcohol, amine, aminosilane, aminoformaldehyde, isocyanate or N-2-hydroxyalkylamide residues. In addition to intramolecular crosslinking of the polymer, crosslinking of the polymer also occurs with the protective colloid shell and with the added additives. Thus, particularly high adhesive forces are achieved.

In the final formulation of the dispersion or of the paste, crosslinkers may still be present, such as e.g. compounds comprising two or more epoxy, organo, halogen, hydroxy, aziridine, carbodiimide, oxazoline, alcohol, amine, aminosilane, aminoformaldehyde, isocyanate or N-2-hydroxyalkylamide residues.

The coatable substrates may be materials of any kind. They may be flexible, hardly flexible, or not flexible at all. Examples are textile materials of any kind, such as fabrics, knitted fabrics, woven fabrics, raschel-knitted goods (natural and synthetic fibers), and fleece made of any material. Further, sheets can be coated, in particular sheets of any kind of plastics, as well as paper, artificial leather, leather, foamed material and wood.

The invention will be explained below by way of an example, without limiting it thereto.

### EXAMPLE 1

Preparation of a Printable Lower Dot Paste from a Polymer Dispersion Without/with a Crosslinking Agent.

Reference dispersion 0: Self-crosslinking acrylate dispersion which has a glass transition temperature T_{g} (DSC)=+2° C., which is emulsifier-stabilized.

Dispersion 1: Vinyl acetate/ethylene dispersion which has a glass transition temperature T_{g} (DSC)=+3° C., which is polyvinyl alcohol-stabilized.

Dispersion 2: Styrene/butadiene dispersion which has a glass transition temperature T_{g} (DSC)=+5° C., which is polyvinyl alcohol-stabilized.

Dispersion 3: Acrylate dispersion which has a glass transition temperature T_{g} (DSC)=+1° C., which is polyvinyl alcohol-stabilized.

Tebelink® B-IC=polisocyanate, modified, Dr. Th. Böhme KG Chem. Fabrik GmbH & Co.

Tebelink® MFA=partially etherified, modified melamine formaldehyde condensate, low in formaldehyde (0.3%), Dr. Th. Böhme KG Chem. Fabrik GmbH & Co.

| | | Reference | | | | | | Acrylate |
|---|---|---|---|---|---|---|---|---|
| Example No. | Water | dispersion | Dispersion 1 | Dispersion 2 | Dispersion 3 | TEBELINK B-IC | TEBELINK MFA | thickener |
| 0a | 61.3 | 34.9 | | | | — | — | 3.8 |
| 1a | 62.7 | | 34.9 | | | — | — | 2.4 |
| 2a | 54.7 | | | 42.0 | | — | — | 3.3 |
| 3a | 58.7 | | | | 38.2 | — | — | 3.1 |
| 0b | 59.3 | 34.9 | | | | 2 | — | 3.8 |
| 1b | 60.7 | | 34.9 | | | 2 | — | 2.4 |
| 2b | 52.7 | | | 42.0 | | 2 | — | 3.3 |
| 3b | 56.7 | | | | 38.2 | 2 | — | 3.1 |
| 0c | 60.3 | 34.9 | | | | — | 1 | 3.8 |
| 1c | 61.7 | | 34.9 | | | — | 1 | 2.4 |
| 2c | 53.7 | | | 42.0 | | — | 1 | 3.3 |
| 3c | 57.7 | | | | 38.2 | — | 1 | 3.1 |

Provide water first, mix in acrylate thickener, until a homogeneous, viscous paste has formed and then add the polymer dispersion with stirring. If crosslinking agents are used, these are added to the paste and mixed in homogeneously.

For improved printability, printing auxiliaries, e.g. alcohols and highly molecular polyethylene oxide, may be added. The paste viscosity varies according to the coating machine. Typical values are between 7,000-15,000 m Pas, Haake Rotovisko VT02, spindle 2.

Printing Process

Rotary screen printing: CP 66 Template, hole diameter 375 μm

Speed: 10 m/min, 150° C. in a drying channel

Dustable powder: Copolyamide, melting range about 115-125° C., 80-160 μm powder

2 substrates: standard fleece (100% PES), fabric (100% PES, strongly hydrophobized, elastic)

Backing

Laminating press of Mayer corporation.

Backing conditions: 127° C., throughput rate 6 m/min, fixing time: 10.5 s, fixing pressure: 4 bar

Backing material: 55% polyester/45% wool

| | Layer | Lower dot | Upper dot | Original | Dry | 40° C. |
|---|---|---|---|---|---|---|
| No. | [g/m²] | [g/m²] | [g/m²] | adhesion | cleaning | Wash (1×) |
| 0a | 11 | 4 | 7 | 8.0 | 6.6 | 8.4 |
| 1a | 11 | 4 | 7 | 11.0 | 10.3 | 8.5 |
| 2a | 11 | 4 | 7 | 11.5 | 10.7 | 8.9 |
| 3a | 11 | 4 | 7 | 9.5 | 9.6 | 7.5 |
| 0b | 11 | 4 | 7 | 8.5 | 8.4 | 7.3 |
| 1b | 11 | 4 | 7 | 11.9 | 10.7 | 9.1 |
| 2b | 11 | 4 | 7 | 12.2 | 10.9 | 9.5 |
| 3b | 11 | 4 | 7 | 10.3 | 10.4 | 8.6 |
| 0c | 11 | 4 | 7 | 8.2 | 7.4 | 8.5 |
| 1c | 11 | 4 | 7 | 11.8 | 10.8 | 9.1 |
| 2c | 11 | 4 | 7 | 12.3 | 11.7 | 9.9 |
| 3c | 11 | 4 | 7 | 10.9 | 10.2 | 8.9 |

1-17. (canceled)

18. A method of double dot coating a substrate comprising the steps of:
applying a protective colloid-stabilized polymer as a lower dot to the substrate, wherein the protective colloid-stabilized polymer comprises a protective colloid and a polymer;
applying a powder adhesive to the protective colloid-stabilized polymer lower dot; and
sintering the protective colloid-stabilized polymer lower dot to the substrate.

19. The method according to claim 18, further comprising the step of selecting the protective colloid from the group consisting of modified natural polymers, synthetic homopolymers and copolymers, graft polymers, and condensation products.

20. The method according to claim 19, further comprising the step of selecting the polymer such that it contains at least one ethylenically unsaturated monomer selected from the group consisting of unbranched vinyl esters of carboxylic acids comprising 1 to 18 carbon atoms, branched alkyl carboxylic acids comprising 1 to 18 carbon atoms, acrylic acid esters of unbranched alcohols or diols comprising 1 to 18 carbon atoms, acrylic acid esters of branched alcohols or diols comprising 1 to 18 carbon atoms, methacrylic acid esters of unbranched alcohols or diols comprising 1 to 18 carbon atoms, methacrylic acid esters of branched alcohols or diols comprising 1 to 18 carbon atoms, C₂-C₂₀ monocarboxylic acids, C₂-C₂₀ dicarboxylic acids, amides of C₂-C₂₀ monocarboxylic acids, amides of C₂-C₂₀ dicarboxylic acids, N-methylol amides of C₂-C₂₀ monocarboxylic acids, N-methylol amides of C₂-C₂₀ dicarboxylic acids, nitriles of C₂-C₂₀ monocarboxylic acids, nitriles of C₂-C₂₀ dicarboxylic acids, C₂-C₂₀ sulfonic acids, 3-20-membered heterocyclic compounds with oxygen, sulfur, selenium, tellurium, nitrogen, phosphorus, boron or aluminum as heteroatom, dienes comprising at least 4 carbon atoms, olefines comprising at least 2 carbon atoms, aromatic vinyl compounds, and C₂-C₂₀ vinyl halides.

21. The method according to claim 20, further comprising the step of selecting the vinyl ester from the group consisting of vinyl acetate, vinyl propionate, vinyl butyrate, vinyl-2-ethyl hexanoate, vinyl laurate, 1-methyl vinyl acetate, vinyl pivalate, and vinyl ester of α-branched monocarboxylic acids comprising 9 to 13 carbon atoms.

22. The method according to claim 20, further comprising the step of selecting the acrylic acid ester or the methacrylic acid ester from the group consisting of methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, and 2-ethyl hexylacrylate.

23. The method according to claim 20, further comprising the step of selecting the monocarboxylic and dicarboxylic acids, their amides, N-methylol amides and nitriles from the group consisting of acrylic acid, methacrylic acid, fumaric acid, maleic acid, acryl amide, N-methylol acryl amide, N-methylol methacryl amide, and acrylonitrile.

24. The method according to claim 20, further comprising the step of selecting the sulfonic acid from vinyl sulfonic acid or 2-acrylamido-2-methylpropane sulfonic acid.

25. The method according to claim 20, further comprising the step of selecting the heterocyclic compound from vinyl pyrrolidone or vinyl pyridine.

26. The method according to claim 20, further comprising the step of selecting the aromatic vinyl compound from the group consisting of styrene, methyl styrene, and vinyl toluene.

27. The method according to claim 20, further comprising the step of selecting the vinyl halide from vinyl chloride.

28. The method according to claim 20, further comprising the step of selecting the olefine from ethylene or propylene.

29. The method according to claim 20, further comprising the step of selecting the diene from 1,3-butadiene or isoprene.

30. The method according to claim 18, further comprising the step of selecting the polymer such that it contains at least one ethylenically unsaturated monomer selected from the group consisting of unbranched vinyl esters of carboxylic acids comprising 1 to 18 carbon atoms, branched alkyl carboxylic acids comprising 1 to 18 carbon atoms, acrylic acid esters of unbranched alcohols or diols comprising 1 to 18 carbon atoms, acrylic acid esters of branched alcohols or diols comprising 1 to 18 carbon atoms, methacrylic acid esters of unbranched alcohols or diols comprising 1 to 18 carbon atoms, methacrylic acid esters of branched alcohols or diols comprising 1 to 18 carbon atoms, C₂-C₂₀ monocarboxylic acids, C₂-C₂₀ dicarboxylic acids, amides of C₂-C₂₀ monocarboxylic acids, amides of C₂-C₂₀ dicarboxylic acids, N-methylol amides of C₂-C₂₀ monocarboxylic acids, N-methylol amides of C₂-C₂₀ dicarboxylic acids, nitriles of C₂-C₂₀ monocarboxylic acids, nitriles of C₂-C₂₀ dicarboxylic acids, C₂-C₂₀ sulfonic acids, 3-20-membered heterocyclic compounds with oxygen, sulfur, selenium, tellurium, nitrogen, phosphorus, boron or aluminum as heteroatom, dienes comprising at least 4 carbon atoms, olefines comprising at least 2 carbon atoms, aromatic vinyl compounds, and C₂-C₂₀ vinyl halides.

31. The method according to claim 18, further comprising the step of selecting the polymer such that it comprises an auxiliary monomer and a monomer, wherein the auxiliary monomer is in an amount of about 0.1% to about 50% by weight, based on the total weight of the polymer.

32. The method according to claim 18, further comprising the step of selecting the polymer such that it has a glass transition temperature Tg of about −50° C. to about 120° C.

33. The method according to claim 18, further comprising the step of selecting the protective colloid-stabilized polymer such that it is present in the form of an aqueous dispersion.

34. The method according to claim 18, further comprising the step of selecting the protective colloid-stabilized polymer such that it is present in the form of paste.

35. The method according to claim 18, further comprising the step of applying the protective colloid-stabilized polymer by rotary screen printing.

36. The method according to claim 18, further comprising the step of adding a meltable adhesive powder to the protective colloid-stabilized polymer.

37. A method of applying a printable lower dot for double dot coating a substrate comprising the steps of:
providing an aqueous dispersion of a protective colloid-stabilized polymer comprising a protective colloid and a polymer; and
applying the protective colloid-stabilized polymer by rotary screen print.

38. The method of claim 37, further comprising the step of selecting the protective colloid from the group consisting of modified natural polymers, synthetic homopolymers and copolymers, graft polymers, and condensation products.

39. The method according to claim 37, further comprising the step of selecting the polymer such that it contains at least one ethylenically unsaturated monomer selected from the group consisting of unbranched vinyl esters of carboxylic acids comprising 1 to 18 carbon atoms, branched alkyl carboxylic acids comprising 1 to 18 carbon atoms, acrylic acid esters of unbranched alcohols or diols comprising 1 to 18 carbon atoms, acrylic acid esters of branched alcohols or diols comprising 1 to 18 carbon atoms, methacrylic acid esters of unbranched alcohols or diols comprising 1 to 18 carbon atoms, methacrylic acid esters of branched alcohols or diols comprising 1 to 18 carbon atoms, C₂-C₂₀ monocarboxylic acids, C₂-C₂₀ dicarboxylic acids, amides of C₂-C₂₀ monocarboxylic acids, amides of C₂-C₂₀ dicarboxylic acids, N-methylol amides of C₂-C₂₀ monocarboxylic acids, N-methylol amides of C₂-C₂₀ dicarboxylic acids, nitriles of C₂-C₂₀ monocarboxylic acids, nitriles of C₂-C₂₀ dicarboxylic acids, C₂-C₂₀ sulfonic acids, 3-20-membered heterocyclic compounds with oxygen, sulfur, selenium, tellurium, nitrogen, phosphorus, boron or aluminum as heteroatom, dienes comprising at least 4 carbon atoms, olefines comprising at least 2 carbon atoms, aromatic vinyl compounds, and C₂-C₂₀ vinyl halides.

40. A method of double dot coating a substrate comprising the steps of:
applying a protective colloid-stabilized polymer to a substrate as a lower dot;
applying an adhesive powder to the protective colloid-stabilized polymer lower dot; and
bonding the protective colloid-stabilized polymer lower dot to the adhesive powder.

41. The method of claim 40, wherein the protective colloid-stabilized polymer comprises a protective colloid and a polymer; further comprises the step of selecting the protective colloid from the group consisting of modified natural polymers, synthetic homopolymers and copolymers, graft polymers, and condensation products; and further comprising the step of selecting the polymer such that it contains at least one ethylenically unsaturated monomer selected from the group consisting of unbranched vinyl esters of carboxylic acids comprising 1 to 18 carbon atoms, branched alkyl carboxylic acids comprising 1 to 18 carbon atoms, acrylic acid esters of unbranched alcohols or diols comprising 1 to 18 carbon atoms, acrylic acid esters of branched alcohols or diols comprising 1 to 18 carbon atoms, methacrylic acid esters of unbranched alcohols or diols comprising 1 to 18 carbon atoms, methacrylic acid esters of branched alcohols or diols comprising 1 to 18 carbon atoms, C₂-C₂₀ monocarboxylic acids, C₂-C₂₀ dicarboxylic acids, amides of C₂-C₂₀ monocarboxylic acids, amides of C₂-C₂₀ dicarboxylic acids, N-methylol amides of C₂-C₂₀ monocarboxylic acids, N-methylol amides of C₂-C₂₀ dicarboxylic acids, nitriles of C₂-C₂₀ monocarboxylic acids, nitrites of C₂-C₂₀ dicarboxylic acids, C₂-C₂₀ sulfonic acids, 3-20-membered heterocyclic compounds with oxygen, sulfur, selenium, tellurium, nitrogen, phosphorus, boron or aluminum as heteroatom, dienes comprising at least 4 carbon atoms, olefines comprising at least 2 carbon atoms, aromatic vinyl compounds, and C₂-C₂₀ vinyl halides.

42. The method of claim 40, further comprising the step of selecting the meltable adhesive powder from a copolyamide with a melting range from about 115-125° C.
